(19) United States
(12) Patent Application Publication
(10) Pub. No.: US 2023/0082683 A1
(43) Pub. Date: Mar. 16, 2023

(54) INDIRECT OPERATING SYSTEM

(71) Applicants: Geeng-Jen SHEU, TAICHUNG CITY (TW); UNISMART TECHNOLOGY CO., LTD., TAICHUNG CITY (TW)

(72) Inventors: Zheng-Yao WANG, TAICHUNG CITY (TW); Geeng-Jen SHEU, TAICHUNG CITY (TW); Chien-Yi CHEN, TAICHUNG CITY (TW); Min-Syong HUANG, TAICHUNG CITY (TW); Shih-Yuan WANG, TAICHUNG CITY (TW)

(21) Appl. No.: 17/943,109

(22) Filed: Sep. 12, 2022

(30) Foreign Application Priority Data
Sep. 14, 2021 (TW) 110134140

(51) Int. Cl. G06F 3/0481; G06F 3/04842; G06F 3/14; G06Q 20/18

(52) U.S. Cl. CPC G06F 3/0481; G06F 3/04842; G06F 3/1454; G06Q 20/18; G06F 3/04886

(57) ABSTRACT

An indirect operating system is suitable for a mobile electronic device to remotely operate a controlled device, and allows the mobile electronic device, after scanning a device barcode of the controlled device, to obtain a corresponding set of user operation pages from a background device and display it on a remote control interface shown by the mobile electronic device, and then, the mobile electronic device converts the user's operation on the user operation page(s) into a control barcode or a driving packet with identification information of the controlled device. Through the driving packet or control barcode, the controlled device can obtain the user's input information and operate according to the input information.

### BACKGROUND

### Field of the Invention

The present invention relates to an operating system, and more particularly to an indirect operating system.

### Description of Related Art

With the advancement of technology and the popularization of touch screens, many automated devices use services that allow users to input relevant information by themselves. For example, the charging mechanism of parking lots has gradually changed from traditional manual charging to fully automated charging. When a driver wants to pay the parking fee, he/she only needs to type the license plate number on the touch display of the automatic payment machine in the parking lot, and the touch display will obtain the information of the fee payable corresponding to the license plate number from the internal management system of the parking lot and show it to the driver, so that the driver can pay the fee at the automatic payment machine according to the displayed fee payable. However, the touch display of the automatic payment machine is used by many people who do not know each other every day, and its surface will inevitably be contaminated with bacteria or viruses, which has become a way of disease transmission. Therefore, with the advent of the post-epidemic era, it is necessary to avoid direct contact with the control interfaces of automation equipment installed in public places for everyone to use, such as but not limited to touch monitors or buttons.

### SUMMARY

Therefore, one objective of the present invention is to provide an indirect operating system, allowing users to remotely operate a controlled device (such as an automatic payment machine, vending machines, ticket vending machines, automatic food ordering machines, automatic queue management machines, automated teller machines (ATMs), or elevators, etc.) to protect users from direct contact with the control interface of the controlled device (such as but not limited to touch displays or buttons, etc.).

Another objective of the present invention is to provide an indirect operating system, which can provide a set of user operation pages corresponding to the control interface of the controlled device, for the user to operate, so that the user can have the feeling of directly and manually operating the control interface of the controlled device.

Yet another objective of the present invention is to provide an indirect operating system, so that when a user remotely operates a controlled device, unexpected or accidental operation on other nearby devices of the same type will not occur due to the comparison or verification of identification information.

To achieve the above and other objectives, an indirect operating system provided by one embodiment of the invention is suitable for being used by a mobile electronic device to remotely operate a controlled device, the mobile electronic device includes a display, a reader, and a processor, the processor is connected to the reader and the display, the controlled device includes a near-end control interface and a control circuit communicating with the near-end control interface, the near-end control interface includes at least one first control option, and the indirect operating system includes: an identification barcode label including a device barcode containing first identification information of the controlled device; a background device, communicable with the mobile electronic device, and including a database for storing at least one set of user operation pages, and each of the at least one set of user operation pages having second identification information; a remote control interface, communicable with the background device and configured to be displayed on the display of the mobile electronic device; and an intermediary communication device communicating with the mobile electronic device and the controlled device. When the reader reads the device barcode, the processor obtains the first identification information contained in the device barcode and transmits the first identification information to the background device, and the background device searches for and obtains the set of user operation pages whose second identification information matches the first identification information, from the database and returns the obtained set of user operation pages to the mobile electronic device, so that the processor displays the obtained set of user operation pages on the remote control interface. The obtained set of user operation pages includes at least one second control option, and the at least one second control option corresponds to the at least one first control option respectively. When the at least one second control option of the set of user operation pages displayed on the remote control interface is selected, the processor obtains input information corresponding to the selected at least one second control option, from the set of user operation pages displayed on the remote control interface, and then, the processor converts the input information and the first identification information into a driving packet and outputs the driving packet. When the controlled device obtains the driving packet through the intermediary communication device, the control circuit acquires the input information and the first identification information from the driving packet, and when the acquired first identification information matches the first identification information of the controlled device, the control circuit operates according to at least a part of the input information.

To achieve the above and other objectives, another indirect operating system provided by one embodiment of the invention is suitable for being used by a mobile electronic device to remotely operate a controlled device, the mobile electronic device includes a display, a first reader, a barcode generator, and a processor, the processor is connected to the display, the first reader and the barcode generator, the controlled device includes a near-end control interface, a second reader and a control circuit communicating with the near-end control interface and the second reader, the near-end control interface includes at least one first control option, and the indirect operating system includes: an identification barcode label including a device barcode containing first identification information of the controlled device; a background device, communicable with the mobile electronic device, and including a database for storing at least one set of user operation pages, and each of the at least one set of user operation pages having second identification information; and a remote control interface, communicable with the background device and configured to be displayed on the display of the mobile electronic device. When the first reader reads the device barcode, the processor obtains the first identification information contained in the device barcode, and transmits the first identification information to the background device, and the background device searches for and obtains the set of user operation pages whose second identification information matches the first identification information, from the database, and returns the obtained set of user operation pages to the mobile electronic device, so that the processor displays the obtained set of user operation pages on the remote control interface. The obtained set of user operation pages includes at least one second control option, and the at least one second control option corresponds to the at least one first control option respectively. When the at least one second control option of the set of user operation pages displayed on the remote control interface is selected, the processor obtains input information corresponding to the selected at least one second control option, from the set of user operation pages displayed on the remote control interface, and then, the processor converts the input information and the first identification information into a control barcode through the barcode generator, and displays the control barcode on the display. When the second reader of the controlled device reads the control barcode, the control circuit acquires the input information and the first identification information from the control barcode, and when the acquired first identification information matches the first identification information of the controlled device, the control circuit operates according to at least a part of the input information.

In some embodiments, either of the first identification information and the second identification information includes at least one of type, brand, model, version and identification code of the controlled device.

In some embodiments, the mobile electronic device and the intermediary communication device communicates with each other through wireless communication technology.

In some embodiments, the intermediary communication device is a Bluetooth gateway.

In some embodiments, the mobile electronic device communicates with the background device through wireless communication technology.

In some embodiments, the controlled device further displays the at least a part of the input information on a near-end control interface of the controlled device.

In some embodiments, the device barcode changes periodically.

In some embodiments, the database is updated periodically.

In some embodiments, the controlled device is an automatic payment machine, an automatic vending machine, an automatic food ordering machine, an automatic queue number dispenser, an automatic teller machine, an automatic ticket vending machine or an elevator.

In some embodiments, when the controlled device obtains the driving packet through the intermediary communication device, the control circuit will acquires the input information and the first identification information from the driving packet through analysis, and when the acquired first identification information matches the first identification information of the controlled device, the control circuit operates according to at least a part of the input information, to acquire payment information corresponding to the input information, from a management system linked to the controlled device and display the payment information on the near-end control interface.

### BRIEF DESCRIPTION OF THE DRAWINGS

After studying the detailed description in conjunction with the following drawings, other aspects and advantages of the present invention will be discovered:

FIG. 1 is a functional block diagram of an indirect operating system allowing a mobile electronic device to remotely operate a controlled device according to an embodiment of the present invention;

FIG. 2 is a flowchart of a method for an direct operating system to allow a mobile electronic device to remotely operate a controlled device according to an embodiment of the present invention;

FIG. 3 is a schematic diagram of an indirect operating system allowing a mobile electronic device to remotely operate a controlled device according to an embodiment of the present invention, for presenting that the mobile electronic device scans a device barcode of the controlled device;

FIG. 4 is a schematic diagram of an indirect operating system allowing a mobile electronic device to remotely operate a controlled device according to an embodiment of the present invention, for presenting a user operation page displayed on the mobile electronic device;

FIG. 5 is a schematic diagram of an indirect operating system allowing a mobile electronic device to remotely operate a controlled device according to an embodiment of the present invention, for presenting a user's operation on a user operation page displayed on the mobile electronic device;

FIG. 6 is a schematic diagram of a controlled device according to an embodiment of the present invention, which is used to present that the controlled device operates according to the operation result of the user on the user operation page(s);

FIG. 7 is a functional block diagram of an indirect operating system allowing a mobile electronic device to remotely operate a controlled device according to an embodiment of the present invention;

FIG. 8 is a flowchart of a method for an indirect operating system to allow a mobile electronic device to remotely operate a controlled device according to an embodiment of the present invention;

FIG. 9 is a schematic diagram of an indirect operating system according to an embodiment of the present invention allowing a mobile electronic device to remotely operate a controlled device, for presenting that the mobile electronic device generates a barcode according to a user's operation result on the user operation page(s);

FIG. 10 is an illustrative view of a part of a controlled device according to an embodiment of the present invention;

FIG. 11 is a schematic diagram of a remote control interface displayed on a mobile electronic device according to an embodiment of the present invention, for presenting a user operation page displayed on the mobile electronic device, for the user to operate;

FIG. 12 is a schematic diagram illustrating that an indirect operating system is applied to an elevator system according to an embodiment of the present invention;

FIG. 13 is a schematic diagram of a remote control interface displayed on a mobile electronic device according to an embodiment of the present invention, for presenting a user operation page displayed on the mobile electronic device for the user to operate; and

FIG. 14 is a schematic diagram of an indirect operating system allowing a mobile electronic device to remotely operate a controlled device according to an embodiment of the present invention, for presenting a user operation page displayed on the mobile electronic device for the user to operate.

### DETAILED DESCRIPTION

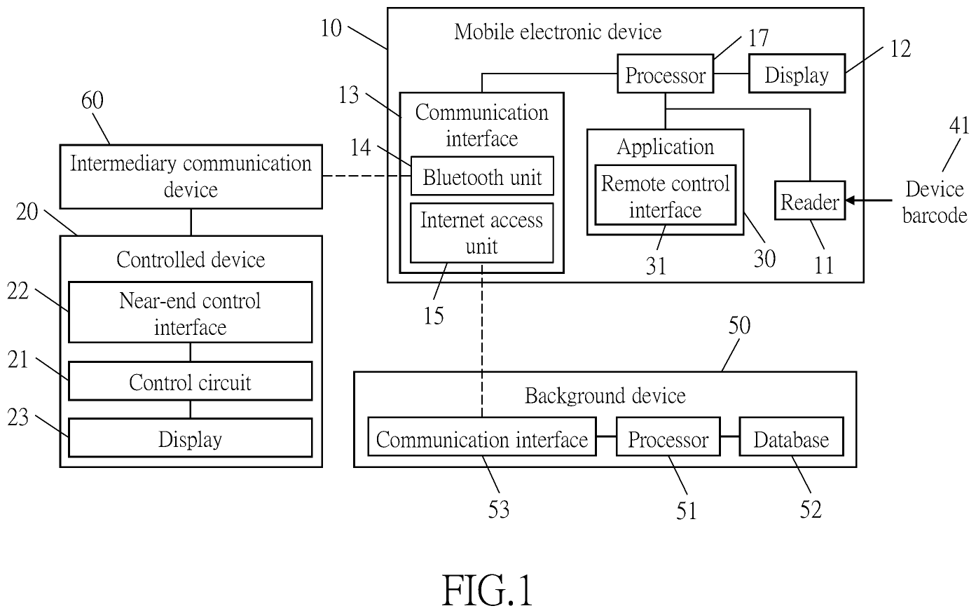

Please refer to FIG. 1, an indirect operating system according to an embodiment of the present invention is suitable for being used by a mobile electronic device 10 to remotely operate a controlled device 20.

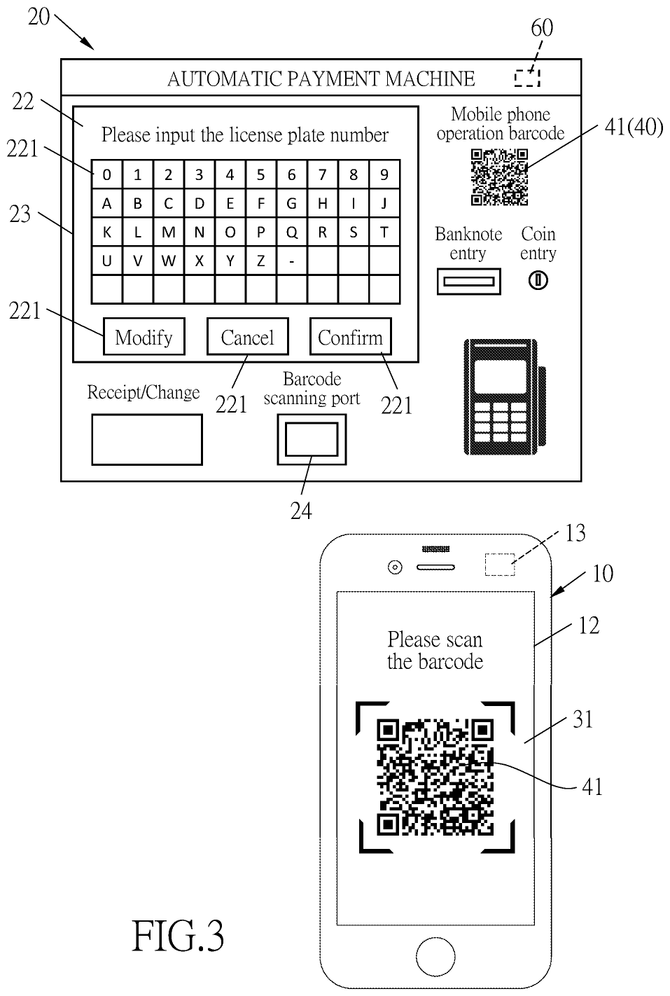

The mobile electronic device 10, as shown in FIG. 1 and FIG. 3, typically includes a processor 17, a storage (not shown), a camera module (not shown), a reader 11 (i.e., a first reader), a display 12 and a communication interface 13. The processor 17 is electrically connected to the storage, the reader 11, the display 12 and the communication interface 13. The reader 11 can be, for example, but not limited to, a barcode reader (such as but not limited to a one-dimensional or two-dimensional barcode reader or a reader of other types of barcodes) consists of a camera module and the processor 17, and the related instructions of the barcode reader can refer to the intrinsic barcode scanners of existing mobile phones. The display 12 may be, for example, a touch display. The communication interface 13 includes, for example, but not limited to, a Bluetooth unit 14 and an Internet access unit 15. Through the Bluetooth unit 14, the mobile electronic device 10 can perform short-distance transmission with other electronic devices; and through the Internet access unit 15, the mobile electronic device 10 can be connected to the Internet for uploading and downloading data.

Therefore, the indirect operating system of the present invention provides an application 30 for a user to download to his mobile electronic device 10 via wireless communication. When the application 30 is started, the application 30 can provide a remote control interface 31 (i.e., a graphical user interface) on the display 12 of the mobile electronic device 10, for the user to operate, as shown in FIGS. 3-6 and 11-14.

The controlled device 20 can be, for example, but not limited to, an automatic payment machine, an automatic vending machine, an automatic food ordering machine, an automatic queue number dispenser, an automatic teller machine, an automatic ticket vending machine or an elevator. The controlled device 20 includes a control circuit 21 and a near-end control interface 22. The control circuit 21 is used to control the operation of the controlled device 20. The near-end control interface 22 can communicate with the control circuit 21, for public operation. The near-end control interface 22 can be, for example, but not limited to, a graphical user interface or a set of physical buttons. The near-end control interface 22 includes at least one control option 221 (i.e., the first control option) that can be operated by users, as shown in FIGS. 3 to 5, 9 to 10 and FIG. 14. The number of control options 221 and the functions of the respective control options are determined according to the type and function of a respective controlled device 20.

In order to achieve the remote operation, the indirect operating system of the present invention further includes an identification barcode label 40, a background device 50 and an intermediary communication device 60.

The identification barcode label 40 may be a physical label posted on or near the controlled device 20. The identification barcode label 40 includes a device barcode 41 (such as but not limited to a two-dimensional barcode). The device barcode 41 contains a piece of identification information (i.e., the first identification information) of the controlled device 20. The identification information of the controlled device 20 may include, for example, but not limited to, the type, brand, model, version, or identification code of the controlled device 20 or any combination thereof. In this embodiment, the identification information of the controlled device 20 includes the type, brand, model, version and identification code of the controlled device 20.

The background device 50 includes a processor 51, at least one database 52 and a communication interface 53. The processor 51 is electrically connected to the at least one database 52 and the communication interface 53. The background device 50 has obtained authorization from the management system of the controlled device 20 in advance, so the at least one database 52 can store multiple sets of user operation pages 32. The multiple sets of user operation pages 32 may be pre-authored with reference to the near-end control interfaces 22 of different controlled devices 20, so each set of user operation pages 32 has its own a piece of identification information (i.e., the second identification information), and each set of user operation pages 32 includes at least one user operation page 32. The identification information of each set of user operation pages 32 may include, for example, but not limited to, the type, brand, model, version, or identification code of a controlled device or any combination thereof. In this embodiment, the identification information of each set of user operation pages 32 includes the type, brand, model, version and identification code of a controlled device.

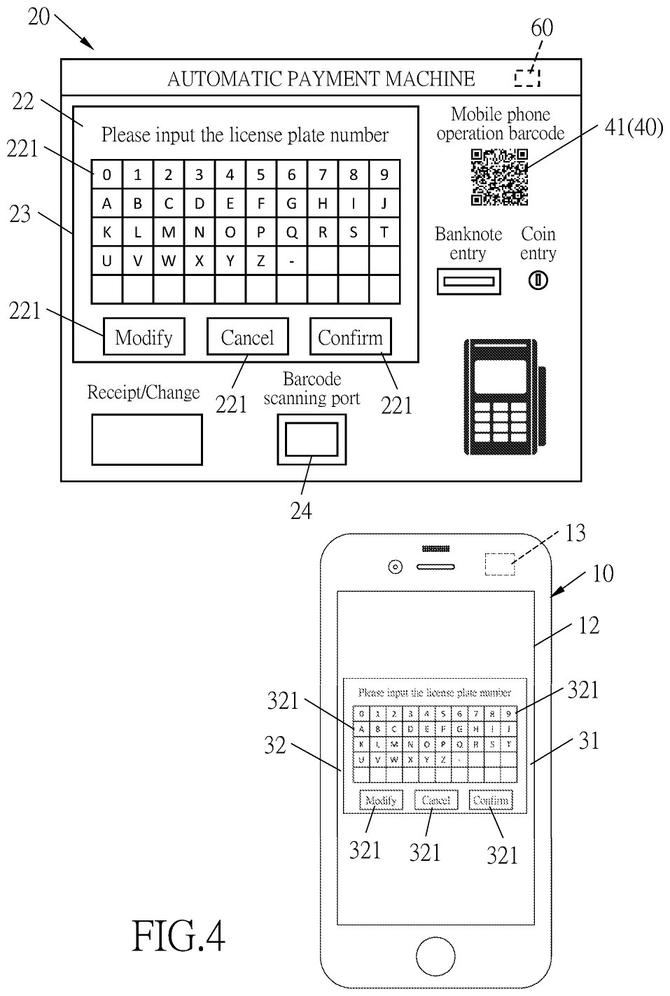

Each set of user operation pages 32 includes at least one control option 321 (i.e., second control option) that can be operated by users, as shown in FIGS. 4 to 5, 11 and 13 to 14. The number of control options 321 on each set of user operation pages 32 and the function of a respective control option 321 are determined according to the number of control options 221 on the near-end control interface 22 of the corresponding controlled device 20 and the functions of the respective control options 221. The one or more control options 321 of the respective set of user operation pages 32 respectively correspond to the one or more control options 221 on the near-end control interface 22 of the corresponding controlled device 20. In addition, the multiple sets of user operation pages 32 stored in the at least one database 52 can be updated periodically as required, so the number of sets of user operation pages 32 can also be increased or decreased periodically as required.

The communication interface 53 is used to connect the background device 50 to the wireless communication network, so the mobile electronic device 10 installed with the application 30 can link to the background device 50 to access data in the background device 50.

The intermediary communication device 60 may be, for example, but not limited to, a Bluetooth gateway, and the Bluetooth gateway may be, for example, but not limited to, a Beacon gateway. The intermediary communication device 60 can be set to be able to identify the identification code of the controlled device 20, whereby the intermediary communication device 60 can communicate with the control circuit 21 of the controlled device 20; and the intermediary communication device 60 can serve as a bridge between the mobile electronic device 10 and the controlled device 20, whereby the mobile electronic device 10 can remotely control the controlled device 20 through the intermediary communication device 60.

In this embodiment, the method for remotely controlling the controlled device 20 by the mobile electronic device 10 is illustrated as follows.

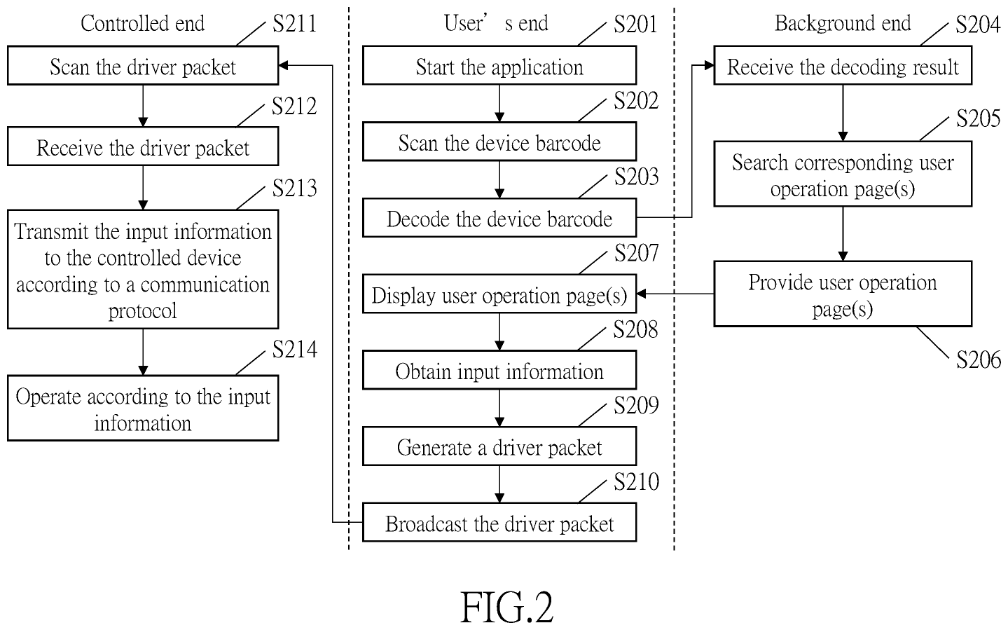

Taking an automatic payment machine in a parking lot as an example of the controlled device 20, as shown in FIG. 2, the method for remotely controlling the controlled device 20 by the mobile electronic device 10 includes the following steps. First, in step S201, a user can start an application 30 after installing the application 30 of the indirect operating system on his mobile electronic device 10. The application 30 displays a remote control interface 31 on the display 12 of the mobile electronic device 10.

Next, in step S202, the user can use the reader 11 of the mobile electronic device 10 to scan an identification barcode label 40 provided on the controlled device 20 to read a device barcode 41 of the identification barcode label 40, as shown in FIG. 3. In step S203, the processor 17 of the mobile electronic device 10 that has read the device barcode 41 decodes the device barcode 41 to obtain the type, brand, model, version and identification code of the controlled device 20 contained in the device barcode 41. After obtaining the type, brand, model, version and identification code of the controlled device 20 contained in the device barcode 41, the processor 17 of the mobile electronic device 10 can submit a page acquisition request to the background device 50 through the Internet access unit 15 of the mobile electronic device 10. The page acquisition request contains the aforementioned decoding result (i.e., the type, brand, model, version and identification code of the controlled device 20 indicated by the device barcode 41).

After the background device 50 receives the above-mentioned page acquisition request through the wireless communication network in step S204, the background device 50 in step S205 searches for and acquires a corresponding set of user operation pages 32 whose identification information (i.e., the second identification information), such as the type, brand, model, version and identification code, conforms to the identification information (i.e., the first identification information), such as the type, brand, model, version and identification code, of the controlled device 20 contained in the above-mentioned page acquisition request, in the at least one database 52 in response to the page acquisition request. Then, in step S206, the background device 50 returns the obtained set of user operation pages 32 to the mobile electronic device 10 according to the wireless communication network address of the mobile electronic device 10 contained in the page acquisition request.

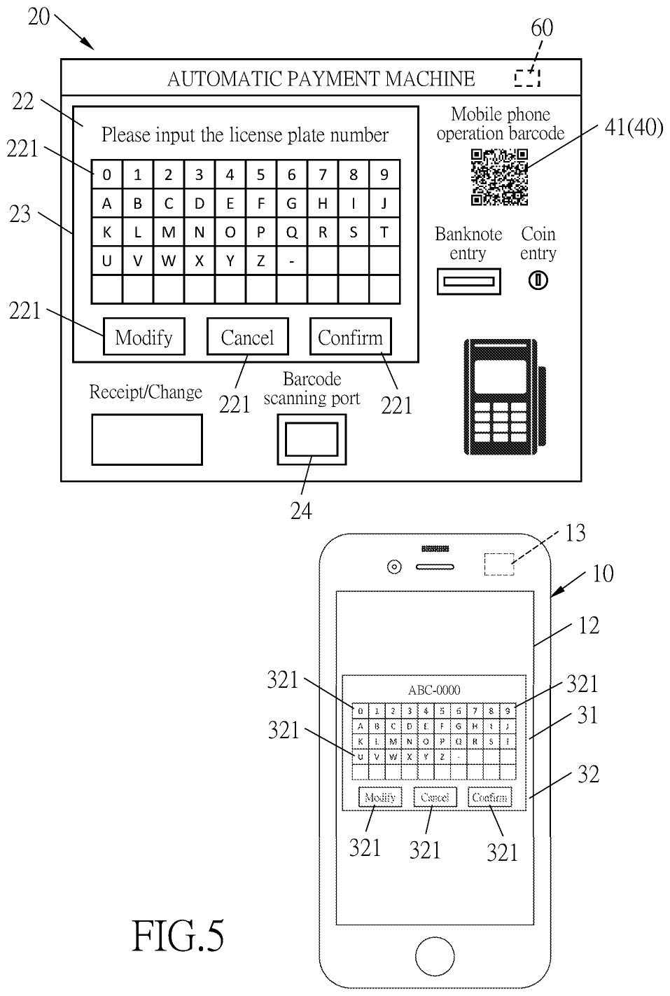

When the processor 17 of the mobile electronic device 10 receives the set of user operation pages 32 provided by the background device 50 through the Internet access unit 15, the processor 17 in step S207 displays the received set of user operation pages 32 one by one on the remote control interface 31 displayed by the display 12 of the mobile electronic device 10 according to a predetermined arrangement, for the user of the mobile electronic device 10 to operate. In this embodiment, a user operation page 32 is displayed on the remote control interface 31 shown by the display 12 of the mobile electronic device 10 for the user of the mobile electronic device 10 to operate, as shown in FIG. 4. Thus, in step S208, the user can input the license plate number (e.g. ABC-0000) of the vehicle driven by the user, on the user operation page 32 displayed on the remote control interface 31 at the mobile electronic device 10, that is, selection is made from one or more control options 321 on the user operation page 32, as shown in FIG. 5; and then, the processor 17 of the mobile electronic device 10 acquires input information, namely, the license plate number, corresponding to the selected control option(s) 321, from the user operation page 32 of the remote control interface 31.

After acquiring the input information, in step S209, the processor 17 of the mobile electronic device 10 converts the input information and the identification code of the controlled device 20 (i.e., part of the first identification information) into a driving packet through the application 30; and in step S210, the driving packet is broadcasted through the Bluetooth unit 14. The format of the driving packet depends on the communication protocol between the mobile electronic device 10 and the Bluetooth gateway as the intermediary communication device 60, such as but not limited to a Bluetooth beacon format.

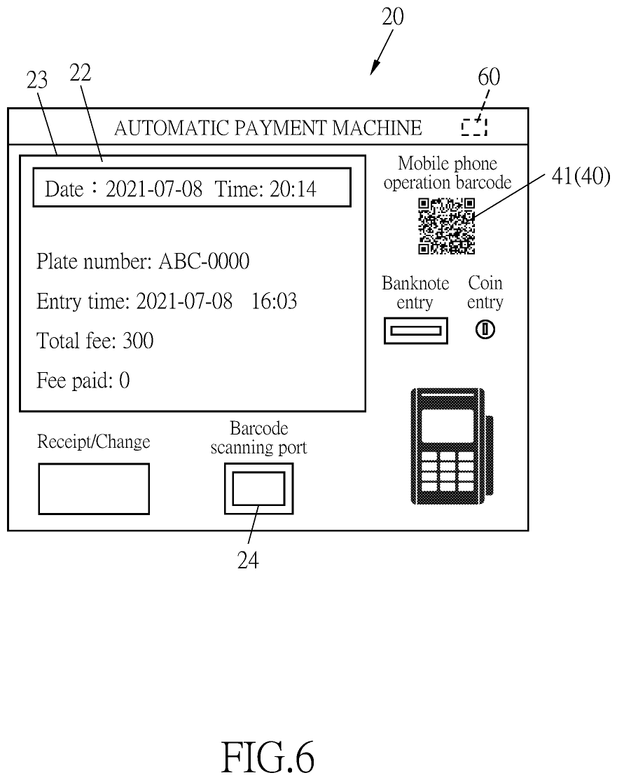

Since the intermediary communication device 60 can scan the surrounding Bluetooth devices and Bluetooth beacons, once the intermediary communication device 60 in step S212 scans the driving packet broadcasted by the mobile electronic device 10 in step S211, the intermediary communication device 60 will receive this driving packet in step S212. Then, the intermediary communication device 60 transmits the driving packet contained in an electronic signal of a predetermined communication protocol, is to the controlled device 20 by in step S213. Since the identification code of the controlled device 20 (i.e., part of the first identification information) is included in the driving packet, other controlled devices will not be controlled accidentally. The controlled device 20 may further include a display 23 electrically connected to the control circuit 21, as shown in FIG. 3. In this embodiment, the display 23 is a touch display, and the near-end control interface 22 is a graphical user interface provided by the control circuit 21, so the display 23 can display the near-end control interface 22 for touch operation by users. When the controlled device 20 receives the input information, that is, the license plate number, from the intermediary communication device 60, the controlled device 20 will operate according to the input information in step S214, to obtain a piece of payment information corresponding to the input information, from the parking lot management system connected to the controlled device 20, and to present the input information together with the payment information on the near-end control interface 22 displayed on the display 23 of the controlled device 20, as shown in FIG. 6, so that the user can make payment according to the payment information.

In this way, the user can remotely operate the controlled device 20 through his mobile electronic device 10 without actually manipulating the near-end control interface 22 by directly touching the display 23 of the controlled device 20 with his hands, thereby preventing the spread of disease.

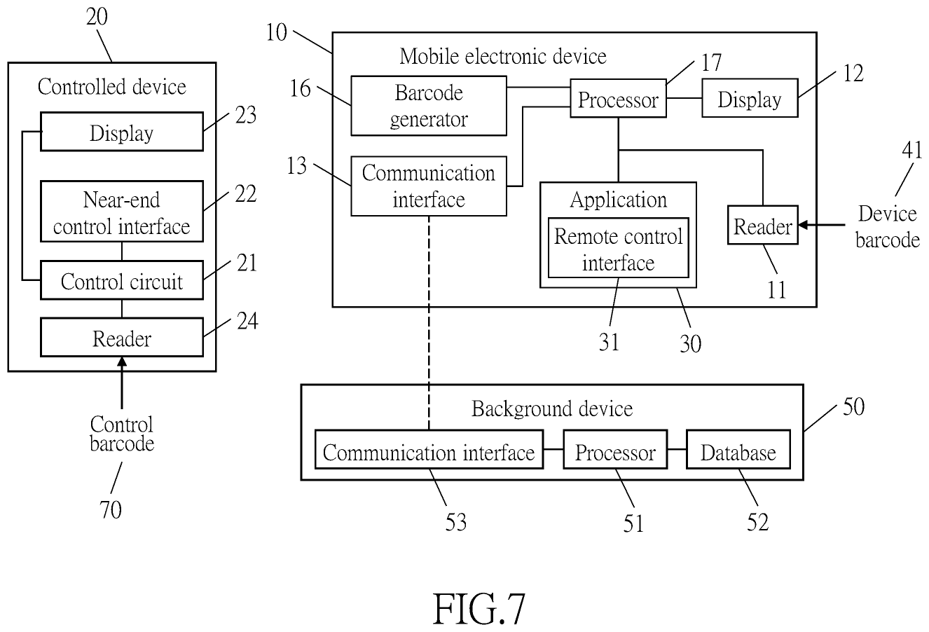

Please refer to FIG. 7, an indirect operating system provided by another embodiment of the present invention is suitable for being used by a mobile electronic device 10 to remotely operate a controlled device 20. In this embodiment, the mobile electronic device 10 further includes a barcode generator 16, and the barcode generator 16 can be realized by the processor 1 of the mobile electronic device 10 and the application 30. The controlled device 20 further includes a reader 24 (i.e., a second reader) electrically connected to the control circuit 21, and the reader 24 may be an existing barcode scanner. The method for remotely controlling the controlled device 20 by the mobile electronic device 10 is exemplarily illustrated as follows.

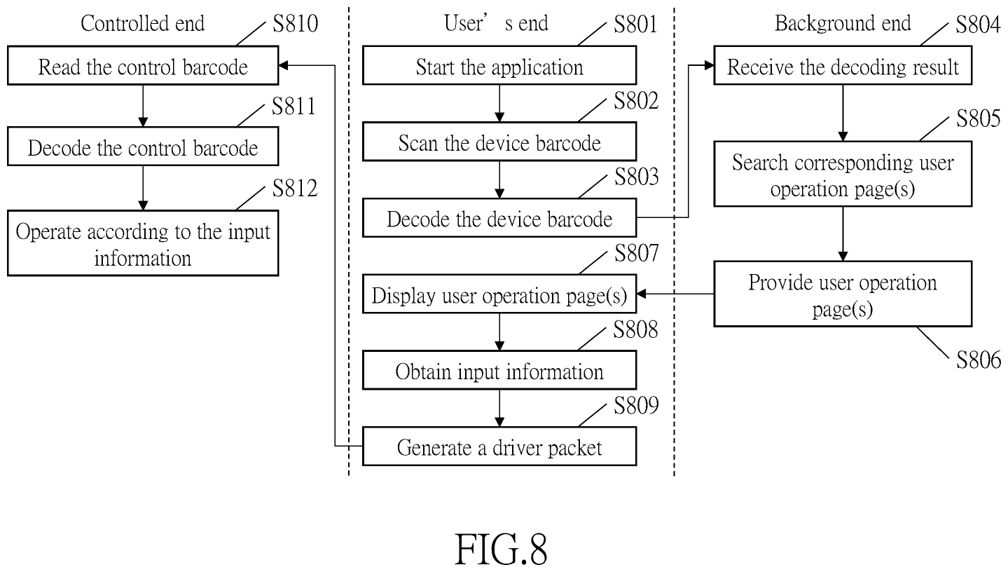

Taking the controlled device 20 as an automatic payment machine in a parking lot as an example, as shown in FIG. 2, the method for remotely controlling the controlled device 20 by the mobile electronic device 10 includes the following steps. First, steps S801 to S808 are performed. Steps S801 to S808 in FIG. 8 are the same or similar to steps S201 to S208 in FIG. 2, so their explanations can refer to the relevant descriptions and drawings of steps S201 to S208.

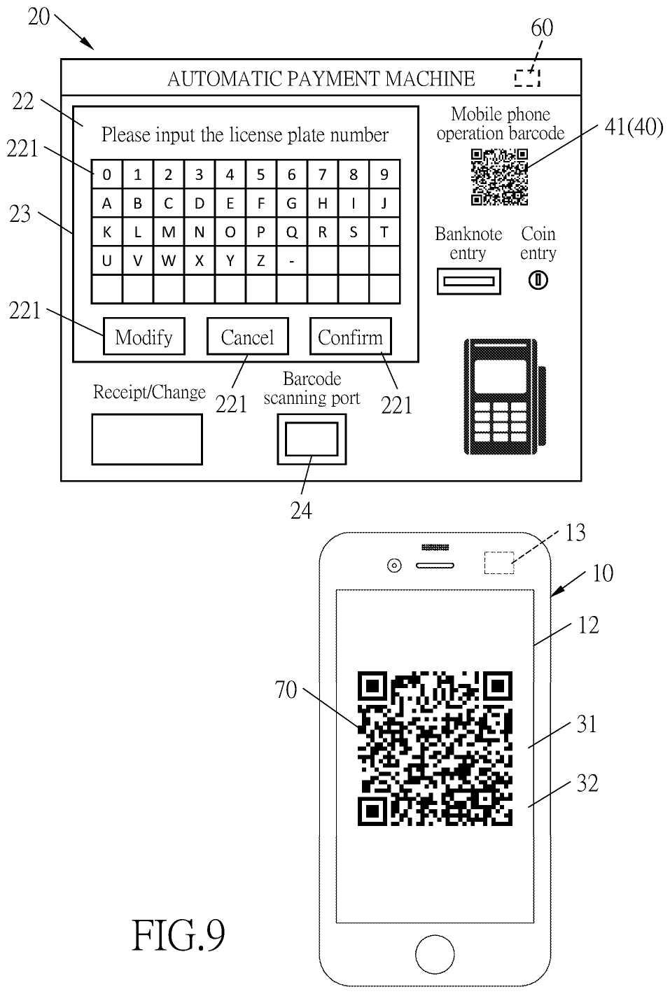

Next, in step S809, after the mobile electronic device 10 obtains the input information (i.e., the license plate number), the barcode generator 16 of the mobile electronic device 10 converts the input information into a control barcode 70 containing the input information, as shown in FIG. 9, and the control barcode 70 is displayed on the remote control interface 31 displayed on the display 12 of the mobile electronic device 10.

Then, in step S810, the user can place the display 12 of the mobile electronic device 10 in the front of the reader 24 of the controlled device 20 to align the control barcode 70 displayed on the display 12 with the reader 24, whereby the reader 24 can scan and read the control barcode 70.

After the reader 24 reads the control barcode 70, the control circuit 21 of the controlled device 20 in step S811 decodes the control barcode 70 to acquire the input information. Then, the control circuit 21 executes step S812. Step S812 in FIG. 8 is the same as or similar to step S214 in FIG. 2, so its explanation can refer to the relevant descriptions and drawings of step S214. In this way, the user can make the payment according to the payment information displayed on the near-end control interface 22.

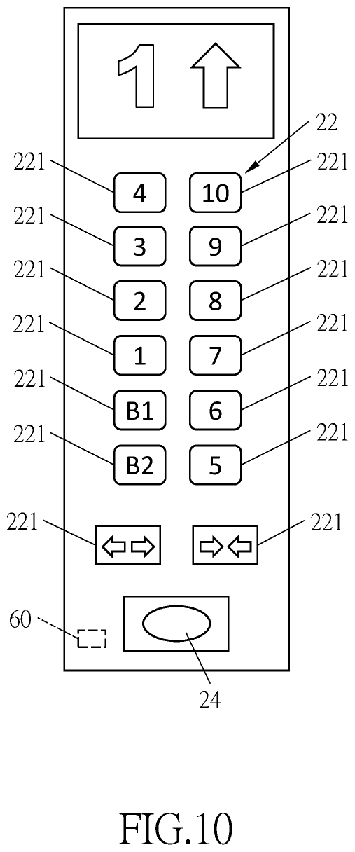

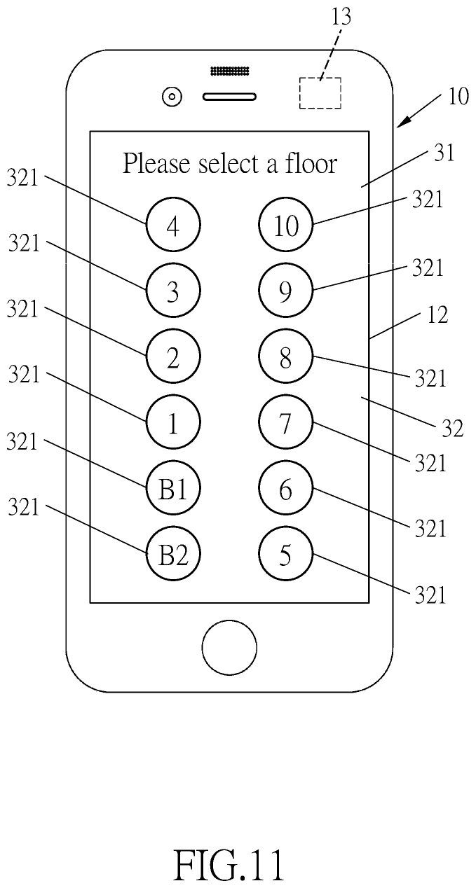

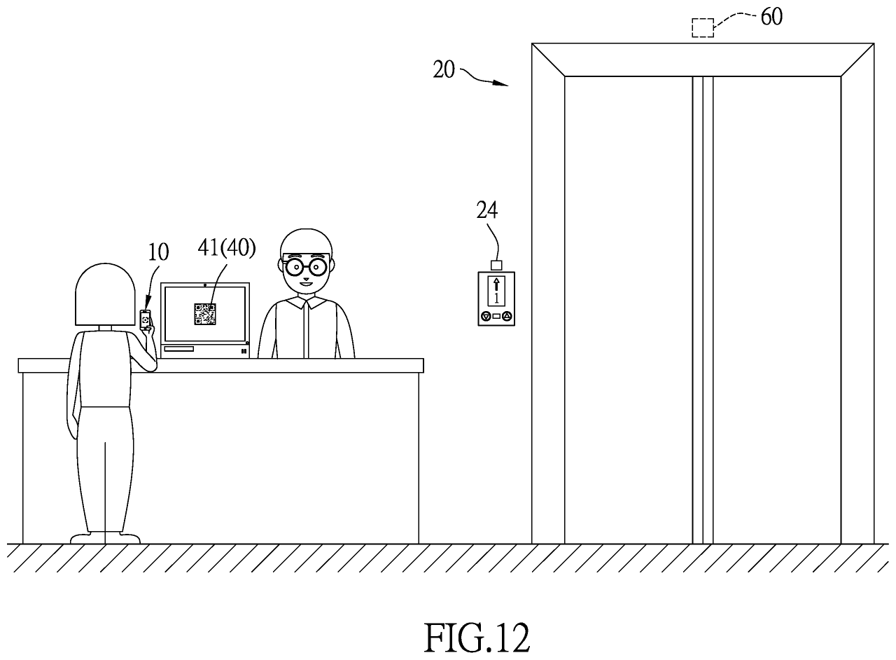

On the other hand, when the indirect operating system of the present invention is applied to an elevator system of an apartment, the controlled device 20 is an elevator of the apartment. The near-end control interface 22 of the controlled device 20 is a plurality of touch buttons or physical buttons inside the elevator car, or touch buttons or physical buttons for up and down stairs at the elevator entrance of each floor. The reader 24 of the controlled device 20 can be installed inside the elevator car or near the elevator entrance of each floor, as shown in FIG. 10 and FIG. 12. An intermediary communication device 60 can also be arranged inside the elevator car and near the elevator entrance of each floor, and these intermediary communication devices 60 can communicate with the control circuit 21 of the controlled device 20 and can identify the identification code of the controlled device 20 (that is, part of the first identification information). The mobile electronic device 10 can obtain a corresponding user operation page 32 and display the user operation page 32 on the remote control interface 31 for the user to operate after scanning the device barcode 41 of the identification barcode label 40 of the elevator. For example, as shown in FIG. 11, the user can press the button corresponding to the desired floor, on the user operation page 32 of the remote control interface 31, and then, the mobile electronic device 10 generates a corresponding driving packet or a control barcode 70. When the control circuit 21 obtains the input information (i.e., the value or serial number represented by the designated floor), the control circuit 21 controls the elevator car to go to the designated floor according to the input information.

In addition, in order to maintain the security of the apartment and control the access of personnel, the identification barcode label 40 of the elevator can be controlled by the administrator (as shown in FIG. 12). Therefore, the user of the mobile electronic device 10 needs to obtain authorization through the application 30, and then the application 30 of the mobile electronic device 10 will generate the driving packet or the control barcode 70. Even at least one of the device barcode 41 and the control barcode 70 is time-sensitive and can be changed, updated or set periodically.

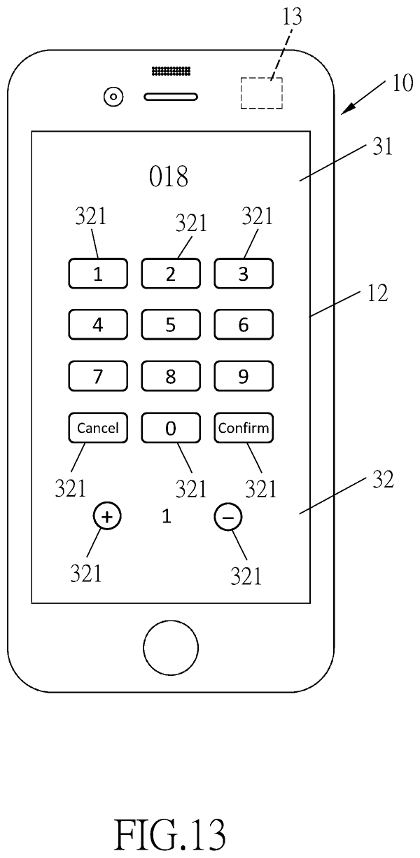

When the indirect operating system of the present invention is applied to a vending machine, the mobile electronic device 10 can obtain a corresponding user operation page 32 and displays the user operation page 32 on the remote control interface 31 for the user to operate after scanning the device barcode 41 of the identification barcode label 40 of the vending machine. For example, as shown in FIG. 13, the user can input the serial number (such as serial number “018”) and quantity (such as quantity “1”) of the commodity to be purchased on the user operation page 32 on the remote control interface 31, then press the confirm button, and the mobile electronic device 10 will generate a corresponding driving packet or a control barcode 70. When the control circuit 21 obtains the input information (i.e., the serial number and quantity of the commodity), the control circuit 21 displays the amount to be paid by the user according to the input information.

In some embodiments of the present invention, the above-mentioned identification barcode label 40 can be changed to an image label displayed on a display, as shown in FIG. 12.

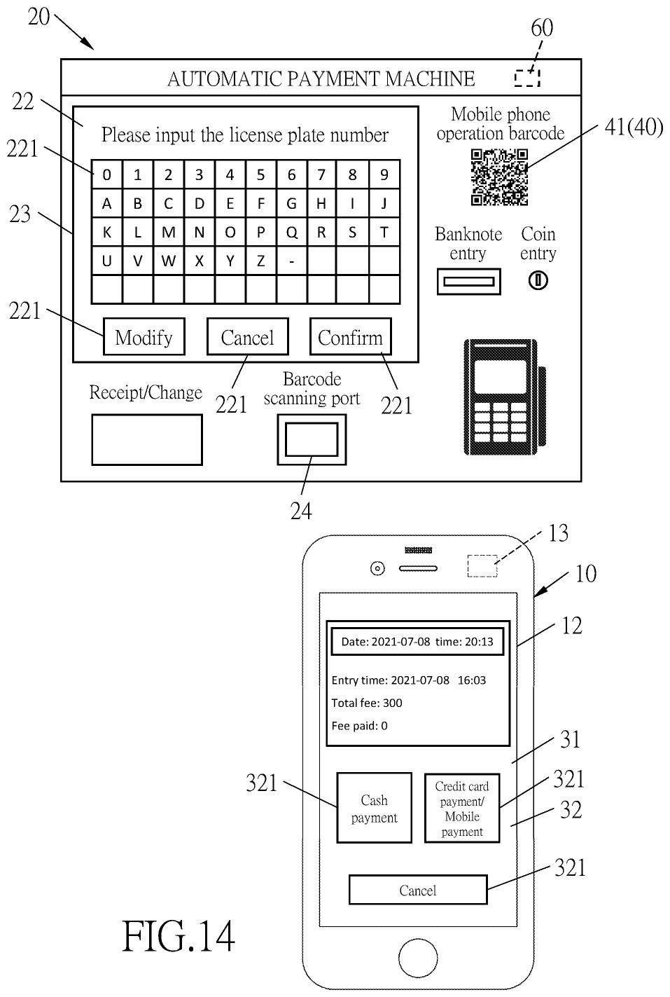

In some embodiments of the present invention, the above-mentioned communication interface 53 of the background device 50 may further communicate with a management system of the controlled device 20 through a wireless communication network after obtaining the authorization for the controlled device 20 from the administrator of the controlled device 20, so as to obtain real-time information from the management system. Moreover, the background device 50 can also correspondingly provide an advanced user operation page 32 together with the real-time information for the user to refer to and perform more advanced operations. Taking the controlled device 20 as an automatic payment machine in a parking lot as an example, when the user inputs a license plate number (for example, the license plate number “ABC-0000”) on a user operation page 32 as shown in FIG.5, the application 30 will provide the license plate number to the background device 50, so that the background device 50 can obtain real-time information (such as but not limited to total fee, entry time, etc.) about the license plate number from the management system of the parking lot according to the license plate number, and send the real-time information back to the application 30 together with a user operation page 32 of the next level, so that the remote control interface 31 will display the user operation page 32 of the next level and present the real-time information, as shown in FIG. 14. In this way, the user can know the total fee and decide further operations (e.g., but not limited to, selecting a payment method or selecting to cancel a transaction, etc.) on the user operation in the two successive levels, a driving packet or a control barcode 70 can be generated correspondingly.

In an embodiment of the present invention, the content and layout presented in the user operation page 32 may be the same as the content and layout that the management system of the controlled device 20 intends to display on the graphical user interface serving as the near-end control interface 22, as shown in FIG. 4. However, the present invention is not limited to this embodiment. In other embodiments of the present invention, the content and layout presented in one user operation page 32 can be simplified, added or adjusted according to requirements, or the content presented in the two user operation pages 32 in the two successive levels can be integrated and simplified as desired, such as shown in FIGS. 6 and 14. Alternatively, in an embodiment of the present invention, the content presented in the user operation page 32 may also simulate part or all of the control options 221 of the near-end control interface 22 shown on the controlled device 20, as shown in FIGS. 10 and 11.

In some embodiments, the display 23 of the controlled device 20 may be omitted or integrated together with the near-end control interface 22 according to the type and specification of the controlled device 20. For example, some vending machines or elevators do not have any display 23, or the near-end control interface 22 and the display 23 of some automatic payment machines in parking lots are integrated to one piece.

To sum up, the remote control interface 31 of the application provided by the indirect operating system of the present invention allows the user to use his mobile electronic device 10 to indirectly operate a controlled device 20 to avoid direct contact with the controlled device 20 of the near-end control interface 22, thereby reducing the risk of disease transmission.

In addition, the indirect operating system of the present invention utilizes barcodes or driving packets to entrain the identification information of the controlled device 20, and by comparing or verifying the identification information at the controlled end, it is possible to prevent other devices surrounding the target controlled object (i.e., the controlled device 20) from being accidentally manipulated.

Furthermore, the indirect operating system of the present invention may refer to the physical or graphical near-end control interface 22 of different types, models and versions of different controlled devices 20 provided by different manufacturers in advance to formulate corresponding user operation pages 32, and/or can pre-integrate and collect the graphical near-end control interface 22 of different types, models and versions of different controlled devices 20 provided by different manufacturers as each user operation page 32, and these user operation pages 32 are stored in the database 52, so the indirect operating system can provide a set of user operation pages 32 corresponding to the near-end control interface 22 of a respective one of various controlled devices 20 to display it on the remote control interface 31 provided by the same application, for the user to operate. In this way, the user can not only indirectly or remotely control the controlled devices 20 of different types, models or versions through the same application, but does not need to download different exclusive applications for the controlled devices 20 of different types, models or versions; and the user can also have the feeling of directly operating the near-end control interface 22 of the controlled device 20 by hand when operating the controlled device 20.

What is claimed is:

1. An indirect operating system being suitable for being used by a mobile electronic device to remotely operate a controlled device, the mobile electronic device comprising a display, a reader, and a processor, the processor being connected to the reader and the display, the controlled device comprising a near-end control interface and a control circuit communicating with the near-end control interface, the near-end control interface comprising at least one first control option, and the indirect operating system comprising:
an identification barcode label comprising a device barcode containing first identification information of the controlled device;
a background device, communicable with the mobile electronic device and comprising a database used for storing at least one set of user operation pages, and each of the at least one set of user operation pages having second identification information;
a remote operating interface communicable with the background device and configured to be displayed on the display of the mobile electronic device; and
an intermediary communication device communicable with the mobile electronic device and the controlled device;
wherein, when the reader reads the device barcode, the processor obtains the first identification information contained in the device barcode and transmits the first identification information to the background device;
the background device obtains, from the database, the set of user operation pages whose second identification information matches the first identification information, and returns the obtained set of user operation pages to the mobile electronic device, so that the processor displays the obtained set of user operation pages on the remote control interface, wherein the obtained set of user operation pages includes at least one second control option, and the at least one second control option corresponds to the at least one first control option respectively;
when the at least one second control option of the set of user operation pages displayed on the remote control interface is selected, the processor obtains input information corresponding to the selected at least one second control option from the set of user operation pages displayed on the remote control interface, and then, the processor converts the input information and the first identification information into a driving packet, and outputs the driving packet; and
when the controlled device obtains the driving packet through the intermediary communication device, the control circuit acquires the input information and the first identification information from the driving packet, and when the acquired first identification information matches the first identification information of the controlled device, the control circuit operates according to at least a part of the input information.

2. The indirect operating system as claimed in claim 1, wherein either of the first identification information and the second identification information comprises at least one of type, brand, model, version and identification code of the controlled device.

3. The indirect operating system as claimed in claim 1, wherein the mobile electronic device and the intermediary communication device communicates with each other through wireless communication technology.

4. The indirect operating system as claimed in claim 3, wherein the intermediary communication device is a Bluetooth gateway.

5. The indirect operating system as claimed in claim 1, wherein the mobile electronic device communicates with the background device through wireless communication technology.

6. The indirect operating system as claimed in claim 1, wherein the controlled device further displays the at least part of the input information on a near-end control interface of the controlled device.

7. The indirect operating system as claimed in claim 1, wherein the device barcode changes periodically.

8. The indirect operating system as claimed in claim 1, wherein the controlled device is an automatic payment machine, an automatic vending machine, an automatic food ordering machine, an automatic queue number dispenser, an automatic teller machine, an automatic ticket vending machine or an elevator.

9. The indirect operating system as claimed in claim 1, wherein the database is updated periodically.

10. An indirect operating system being suitable for being used by a mobile electronic device to remotely operate a controlled device, the mobile electronic device comprising a display, a first reader, a barcode generator, and a processor, the processor being connected to the display, the first reader and the barcode generator, the controlled device comprising a near-end control interface, a second reader and a control circuit communicating with the near-end control interface and the second reader, the near-end control interface comprising at least one first control option, and the indirect operating system comprising:
an identification barcode label comprising a device barcode containing first identification information of the controlled device;
a background device, communicable with the mobile electronic device, and comprising a database, the database being used for storing at least one set of user operation pages, and each of the at least one set of user operation pages having second identification information; and
a remote control interface, communicable with the background device and configured to be displayed on the display of the mobile electronic device;
wherein, when the first reader reads the device barcode, the processor obtains the first identification information contained in the device barcode, and transmits the first identification information to the background device;
the background device obtains, from the database, the set of user operation pages whose second identification information matches the first identification information, and returns the obtained set of user operation pages to the mobile electronic device, so that the processor displays the obtained set of user operation pages on the remote control interface, wherein the obtained set of user operation pages comprises at least one second control option, and the at least one second control option corresponds to the at least one first control option respectively;
when the at least one second control option of the set of user operation pages displayed on the remote control interface is selected, the processor obtains input information corresponding to the selected at least one second control option from the set of user operation pages displayed on the remote control interface, and then, the processor converts the input information and the first identification information into a control barcode through the barcode generator, and displays the control barcode on the display; and
when the second reader of the controlled device reads the control barcode, the control circuit acquires the input information and the first identification information from the control barcode, and when the acquired first identification information matches the first identification information of the controlled device, the control circuit operates according to at least a part of the input information.

11. The indirect operating system as claimed in claim 1, wherein either of the first identification information and the second identification information include at least one of type, brand, model, version and identification code of the controlled device.

12. The indirect operating system as claimed in claim 10, wherein the mobile electronic device communicates with the background device through wireless communication technology.

13. The indirect operating system as claimed in claim 10, wherein the controlled device further displays the at least a part of the input information on the near-end control interface of the controlled device.

14. The indirect operating system as claimed in claim 10, wherein the control barcode changes periodically.

15. The indirect operating system as claimed in claim 10, wherein the controlled device is an automatic payment machine, an automatic vending machine, an automatic food ordering machine, an automatic queue number dispenser, an automatic teller machine, an automatic ticket vending machine or an elevator.

16. The indirect operating system as claimed in claim 10, wherein the database is updated periodically.
